(19) United States
(12) Patent Application Publication
(10) Pub. No.: US 2020/0276571 A1
(43) Pub. Date: Sep. 3, 2020

(54) A PROCESS FOR PREPARING AN IRON CONTAINING ZEOLITIC MATERIAL HAVING AN AEI FRAMEWORK STRUCTURE USING A QUATERNARY PHOSPHONIUM CATION

(71) Applicant: BASF SE, Ludwigshafen am Rhein (DE)

(72) Inventors: Mathias FEYEN, Ludwigshafen (DE); Ulrich MUELLER, Ludwigshafen (DE); Xinhe BAO, Dalian City (CN); Weiping ZHANG, Dalian City (CN); Dirk DE VOS, Leuven (BE); Hermann GIES, Bochum (DE); Feng-Shou XIAO, Hangzhou (CN); Toshiyuki YOKOI, Tokyo (JP); Ute KOLB, Mainz (DE); Bernd MARLER, Bochum (DE); Yong WANG, Tokyo (JP); Trees DE BAERDEMAEKER, Leuven (BE); Chuan SHI, Dalian City (CN); Xiangju MENG, Hangzhou (CN); Xiulian PAN, Dalian City (CN)

(73) Assignee: BASF SE, Ludwigshafen am Rhein (DE)

(21) Appl. No.: 16/765,606

(22) PCT Filed: Nov. 8, 2018
(86) PCT No.: PCT/CN2018/114590

§ 371 Date: May 20, 2020

(30) Foreign Application Priority Data
Nov. 22, 2017 (CN) PCT/CN2017/112343

(51) Int. Cl. B01J 37/08; B01J 37/30; B01J 29/76; C01B 39/48

(52) U.S. Cl. CPC B01J 37/08; B01J 37/30; B01J 2229/183; C01B 39/48; B01J 29/76

(57) ABSTRACT

Provided are a process for the preparation of an iron containing zeolitic material having an AEI framework structure using a quaternary phosphonium cation, as well as an iron containing zeolitic material per se as obtainable or obtained according to the process. Furthermore, an exhaust gas treatment system comprising the iron containing zeolitic material and the use of the iron containing zeolitic material as a catalyst are provided.

### TECHNICAL FIELD

The present invention relates to a process for the preparation of an of an iron containing zeolitic material having an AEI framework structure, as well as to an iron containing zeolitic material per se as obtainable or obtained according to said process. Furthermore, the present invention relates to an exhaust gas treatment system comprising said iron containing zeolitic material. Furthermore, the present invention relates to the use of the iron containing zeolitic material as a catalyst.

### INTRODUCTION

Zeolitic materials having framework type AEI are known to be potentially effective as catalysts or catalyst components for treating combustion exhaust gas in industrial applications, for example for converting nitrogen oxides (NOₓ) in an exhaust gas stream. Synthetic AEI zeolitic materials are generally produced by precipitating crystals of the zeolitic material from a synthesis mixture which contains the sources of the elements from which the zeolitic framework is built, such as a source of silicon and a source of aluminum. An alternative approach may be the preparation via zeolitic framework conversion according to which a starting material which is a suitable zeolitic material having a framework type other than AEI is suitably reacted to obtain the zeolitic material having framework type AEI. In this light, AEI zeolitic materials may be tailored such that they contain Fe, which may by advantageous to the catalytic properties, although the iron loading may be limited by the processing conditions.

There is therefore a need for an improved process for preparing an iron containing zeolitic material having an AEI framework which overcomes the limitations of the prior art.

U.S. Pat. No. 5,958,370 relates to SSZ-39 and to its preparation using cyclic or polycyclic quaternary ammonium cations as templating agent.

Moliner, M. et al. in Chem. Commun. 2012, 48, pages 8264-8266 concerns Cu-SSZ-39 and its use for the SCR of nitrogen oxides NOx, wherein the SSZ-39 is produced with the use of N,N-dimethyl-3,5-dimethylpiperidinium cations as the organotemplate.

Maruo, T. et al. in Chem. Lett. 2014, 43, page 302-304 relates to the synthesis of AEI zeolites by hydrothermal conversion of FAU zeolites in the presence of tetraethylphosphonium cations.

Martin, N. et al. in Chem. Commun. 2015, 51, 11030-11033 concerns the synthesis of Cu-SSZ-39 and its use as a catalyst in the SCR of nitrogen oxides NOx. As regards the methods of synthesis of the SSZ-39 zeolite in said document, these include the use of N,N-dimethyl-3,5-dimethylpiperidinium cations as well as of tetraethylphosphonium cations.

US 2011/0250127 A1 relates to a method of converting nitrogen oxides NOx via SCR in the presence of a small pore zeolite containing a transition metal. A preferred framework type according to said document is AEI, wherein preferably Fe or Cu are employed as the transition metal.

Martin, N. et al. in Chem Cat Chem 2017, 9, 1754 concerns the preparation of iron-containing SSZ-39 and to its use in the SCR of nitrogen oxides NOx.

There remains a need for the provision of an improved process, in particular with regard to readily giving access to AEI zeolitic materials with high loadings of iron. Furthermore, there remains a need for a process which allows high loadings of iron to be achieved, whilst cost effectively utilizing the iron employed in the ion-exchange procedure whilst reducing waste.

### DETAILED DESCRIPTION

It was therefore an object of the present invention to provide an improved process for preparing an iron containing zeolitic material having an AEI framework which is economically and environmentally advantageous, whilst giving access to catalysts with high loadings of iron. Thus, it has surprisingly been found that a process for the preparation of an of an iron containing zeolitic material having an AEI framework structure can advantageously be carried out with one or more quaternary phosphonium (QP) cation containing compounds as structure directing agent, wherein calcination of the AEI framework structure under hydrogen for removing the organo-template is carried out prior to the ion-exchange procedure with Fe.

Therefore, the present invention relates to a process for the preparation of an iron containing zeolitic material having an AEI framework structure comprising YO₂ and X₂O₃, wherein said process comprises:
(1) preparing a mixture comprising one or more sources for YO₂, one or more sources for X₂O₃, and one or more quaternary phosphonium (QP) cation containing compounds as structure directing agent;
(2) heating the mixture obtained in (1) and obtaining a zeolitic material having an AEI framework structure;
(3) calcining the zeolitic material obtained in (2) under a hydrogen gas containing atmosphere;
(4) subjecting the zeolitic material obtained in (3) to an ion-exchange procedure with one or more Fe²⁺ and/or Fe³⁺ containing salts, preferably with one or more Fe²⁺ containing salts, for obtaining an iron containing zeolitic material having an AEI framework structure; wherein Y is a tetravalent element, and X is a trivalent element.

As to step (4), it is preferred that the molar ratio Fe:YO₂ of iron to YO₂ of the zeolitic material obtained in (4) is in the range of from 0.001 to 0.15, preferably of from 0.005 to 0.1, more preferably of from 0.01 to 0.07, more preferably of from 0.015 to 0.05, more preferably of from 0.02 to 0.045, more preferably of from 0.023 to 0.04, more preferably of from 0.025 to 0.035, more preferably of from 0.027 to 0.033, and more preferably of from 0.029 to 0.031.

As to step (3), it is preferred that in (3) the hydrogen gas containing atmosphere contains hydrogen gas in the range of from 20 to 100 vol.-%, preferably from 40 to 100 vol.-%, more preferably from 60 to 100 vol.-%, more preferably from 80 to 100 vol.-%, more preferably from 90 to 100 vol.-%, more preferably from 95 to 100 vol.-%, more preferably from 98 to 100 vol.-%, and more preferably from 99 to 100 vol.-%, wherein more preferably hydrogen gas is employed as the atmosphere for the calcining of the zeolitic material in (3).

Preferably, in (3) the hydrogen gas containing atmosphere further comprises one or more inert gases in addition to hydrogen gas, wherein preferably the hydrogen gas containing atmosphere further comprises one or more inert gases selected from the group consisting of nitrogen, helium, neon, argon, xenon, carbon monoxide, carbon dioxide, and mixtures of two or more thereof, more preferably from the group consisting of nitrogen, argon, carbon monoxide, carbon dioxide, and mixtures of two or more thereof, wherein more preferably the hydrogen gas containing atmosphere further comprises nitrogen and/or argon, and more preferably nitrogen.

Preferably, in (3) the hydrogen gas containing atmosphere contains 1 vol.-% or less of oxygen gas, preferably 0.5 vol.-% or less, more preferably 0.1 vol.-% or less, more preferably 0.05 vol.% or less, more preferably 0.01 vol.-% or less, more preferably 0.005 vol.-% or less, more preferably 0.001 vol.-% or less, more preferably 0.0005 vol.-% or less, and more preferably 0.0001 vol.-% or less, wherein more preferably the hydrogen gas containing atmosphere does not contain oxygen gas.

Calcination in (3) is preferably conducted at a temperature in the range of from 400 to 850° C., preferably from 450 to 700° C., more preferably from 550 to 650° C., and more preferably from 575 to 625° C. Calcination in (3) is preferably conducted for a duration in the range of from 2 to 48 h, preferably from 3 to 24 h, more preferably from 4 to 12 h, more preferably from 4.5 to 8 h, and more preferably from 5 to 6 h.

With regard to step (1) and the one or more quaternary phosphonium (QP) cation containing compounds as structure directing agent, while there are no specific restrictions, it is preferred that the one or more quaternary phosphonium cation containing compounds comprise one or more R¹R²R³R⁴P⁺-containing compounds, wherein R¹, R², R³, and R⁴ independently from one another stand for optionally substituted and/or optionally branched (C₁-C₆)alkyl, preferably (C₁-C₅)alkyl, more preferably (C₁-C₄)alkyl, more preferably (C₂-C₃)alkyl, and more preferably for optionally substituted methyl or ethyl, wherein more preferably R¹, R², R³, and R⁴ stand for optionally substituted ethyl, preferably unsubstituted ethyl.

The term “C₁-C₆ alkyl” as used in the context of the present invention refers to an alkyl residue having from 1 to 6 carbon atoms in the chain. The alkyl residue may have, for example, 1, 2, 3, 4, 5 carbon atoms in the chain (C₁-C₅ alkyl) or 1, 2, 3, or 4 carbon atoms in the chain (C₁-C₄ alkyl).

The term “optionally substituted” as used in the context of the present invention is to be understood to include any suitable substituent conceivable for the skilled person to be comprised in the quaternary phosphonium (QP) cation containing compounds, which does not prevent its function as the structure directing agent according to the present process.

Preferably, in (1) the one or more quaternary phosphonium (QP) cation containing compounds are salts, preferably one or more salts selected from the group consisting of halides, preferably chloride and/or bromide, more preferably chloride, hydroxide, sulfate, nitrate, phosphate, acetate, and mixtures of two or more thereof, more preferably from the group consisting of chloride, hydroxide, sulfate, and mixtures of two or more thereof, wherein more preferably the one or more quaternary phosphonium cation containing compounds and/or the one or more quaternary ammonium cation containing compounds are hydroxides and/or chlorides, and more preferably hydroxides.

In the context of the present invention Y may be any tetravalent element. Preferably, Y is selected from the group consisting of Si, Sn, Ti, Zr, Ge, and mixtures of two or more thereof, Y more preferably being Si. Generally, according to (1), any suitable one or more sources for YO₂ can be used. Preferably, in (1) the one or more sources for YO₂ comprises one or more compounds selected from the group consisting of zeolites having a FAU framework structure, fumed silica, silica hydrosols, reactive amorphous solid silicas, silica gel, silicic acid, alkali metal silicates, sodium metasilicate hydrate, sesquisilicate, disilicate, colloidal silica, silicic acid esters, and mixtures of two or more thereof, more preferably from the group consisting of zeolites having a FAU framework structure, fumed silica, sodium silicate, potassium silicate, and mixtures of two or more thereof, more preferably from the group consisting of zeolites having a FAU framework structure, fumed silica, and mixtures of two or more thereof, wherein more preferably the one or more sources for YO₂ comprises one or more zeolites having a FAU framework structure, more preferably one or more zeolites having a FAU framework structure selected from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, Na-X, US-Y, ECR-30, LZ-210, Li-LSX, SAPO-37, Na-Y, ZSM-20, ZSM-3, Zeolite X, Zeolite Y, and mixtures of two or more thereof, more preferably from the group consisting of faujasite, Na-X, US-Y, LZ-210, zeolite X, zeolite Y, and mixtures of two or more thereof, wherein more preferably the one or more sources for YO₂ comprises zeolite Y and/or US-Y, preferably zeolite Y, wherein more preferably zeolite Y and/or US-Y is employed as the source for YO₂, and more preferably zeolite Y.

In the context of the present invention X may be any trivalent element. Preferably, X is selected from the group consisting of Al, B, In, Ga, and mixtures of two or more thereof, X more preferably being Al and/or B, and more preferably being Al. Generally, according to (1), any suitable one or more sources for X₂O₃ can be used. Preferably, in (1) the one or more sources for X₂O₃ comprises one or more compounds selected from the group consisting of zeolites having a FAU framework structure, alumina, aluminates, aluminum salts, and mixtures of two or more thereof, more preferably from the group consisting of zeolites having a FAU framework structure, alumina, aluminum salts, and mixtures of two or more thereof, more preferably from the group consisting of zeolites having a FAU framework structure, alumina, aluminum tri(C₁-C₅)alkoxide, AlO(OH), Al(OH)₃, aluminum halides, aluminum sulfate, aluminum phosphate, aluminum fluorosilicate, and mixtures of two or more thereof, more preferably from the group consisting of zeolites having a FAU framework structure, aluminum tri(C₂-C₄)alkoxide, AlO(OH), Al(OH)₃, aluminum chloride, aluminum sulfate, aluminum phosphate, and mixtures of two or more thereof, more preferably from the group consisting of zeolites having a FAU framework structure, aluminum tri(C₂-C₃)alkoxide, AlO(OH), Al(OH)₃, aluminum chloride, aluminum sulfate, and mixtures of two or more thereof, more preferably from the group consisting of zeolites having a FAU framework structure, Al(OH)₃, and mixtures of two or more thereof, wherein more preferably the one or more sources for X₂O₃ comprises one or more zeolites having a FAU framework structure, more preferably one or more zeolites having a FAU framework structure selected from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, Na-X, US-Y, ECR-30, LZ-210, Li-LSX, SAPO-37, Na-Y, ZSM-20, ZSM-3, Zeolite X, Zeolite Y, and mixtures of two or more thereof, more preferably from the group consisting of faujasite, Na-X, US-Y, LZ-210, zeolite X, zeolite Y, and mixtures of two or more thereof, wherein more preferably the one or more sources for YO₂ comprises zeolite Y and/or US-Y, preferably zeolite Y, wherein more preferably zeolite Y and/or US-Y is employed as the source for YO₂, and more preferably zeolite Y.

Preferably, in (1) the one or more sources for YO₂ and the one or more sources for X₂O₃ comprise one or more zeolites having a FAU framework structure, more preferably one or more zeolites having a FAU framework structure selected from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, Na-X, US-Y, ECR-30, LZ-210, Li-LSX, SAPO-37, Na-Y, ZSM-20, ZSM-3, zeolite X, zeolite Y, and mixtures of two or more thereof, more preferably from the group consisting of faujasite, Na-X, US-Y, LZ-210, zeolite X, zeolite Y, and mixtures of two or more thereof, wherein more preferably the one or more sources for YO₂ and the one or more sources for X₂O₃ comprise zeolite Y and/or US-Y, preferably zeolite Y, wherein more preferably zeolite Y and/or US-Y is employed as the source for YO₂ and X₂O₃, and more preferably zeolite Y.

In (1), preferably the one or more sources for YO₂ and the one or more sources for X₂O₃ comprise one or more zeolites having a FAU framework structure, more preferably one or more zeolites having a FAU framework structure selected from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, Na-X, US-Y, ECR-30, LZ-210, Li-LSX, SAPO-37, Na-Y, ZSM-20, ZSM-3, zeolite X, zeolite Y, and mixtures of two or more thereof, more preferably from the group consisting of faujasite, Na-X, US-Y, LZ-210, zeolite X, zeolite Y, and mixtures of two or more thereof, wherein more preferably the one or more sources for YO₂ and the one or more sources for X₂O₃ comprise zeolite Y and/or US-Y, preferably zeolite Y, wherein more preferably zeolite Y and/or US-Y is employed as the source for YO₂ and X₂O₃, and more preferably zeolite Y.

The mixture prepared in (1) preferably further comprises one or more sources for Z₂O₅, wherein Z is a pentavalent element, Z preferably being P and/or As, wherein more preferably Z is P. Preferably, the one or more sources for Z₂O₅ comprises one or more phosphates and/or one or more oxides and/or one or more acids of phosphorous, preferably one or more acids of phosphorous, more preferably phosphoric acid, and wherein more preferably the source for Z₂O₅ is phosphoric acid.

The mixture prepared according to (1) preferably further comprises one or more solvents, wherein said one or more solvents preferably comprises water, preferably distilled water, wherein more preferably water is contained as the one or more solvents in the mixture prepared according to (1), preferably distilled water. While there are no specific restrictions, it is preferred that the molar ratio H₂O:YO₂ of water to the one or more sources for YO₂ calculated as YO₂ in the mixture prepared according to (1) ranges from 1 to 80, preferably from 1.5 to 50, more preferably from 2 to 30, more preferably from 2.5 to 15, more preferably from 3 to 10, more preferably from 3.5 to 8, more preferably from 4 to 6, and more preferably from 4.5 to 5.5. While there are no specific restrictions, it is preferred that the molar ratio QP:YO₂ of the one or more quaternary phosphonium cations to the one or more sources for YO₂ calculated as YO₂ in the mixture prepared according to (1) ranges from 0.01 to 2, preferably from 0.05 to 1.5, more preferably from 0.1 to 1, more preferably from 0.3 to 0.8, more preferably from 0.5 to 0.5, more preferably from 0.8 to 0.4, more preferably from 0.1 to 0.35, more preferably from 0.12 to 0.3, more preferably from 0.15 to 0.25, more preferably from 0.17 to 0.23, and more preferably from 0.19 to 0.21.

As to step (2), it is preferred that in (2) the mixture is heated at a temperature ranging from 90 to 250° C., preferably from 110 to 230° C., more preferably from 130 to 210° C., more preferably from 150 to 190° C., more preferably from 160 to 180° C., and more preferably from 165 to 175° C. Preferably, the heating in (2) is conducted under autogenous pressure, preferably under solvothermal conditions, more preferably under hydrothermal conditions. In (2) the mixture preferably is heated for a period ranging from 0.25 to 12 d, preferably from 0.5 to 9 d, more preferably from 1 to 8 d, more preferably from 2 to 7.5 d, more preferably from 3 to 7 d, more preferably from 3.5 to 6.5 d, more preferably from 4 to 6 d, and more preferably from 4.5 to 5.5 d. Preferably, the heating in (2) involves agitating the mixture, preferably by stirring.

There are no specific restrictions on how the obtained zeolitic material having an AEI framework structure may be separated. Preferably, after (2) and prior to (3), the process further comprises one or more of:

(2a) isolating the zeolitic material obtained in (2), preferably by filtration, and/or

(2b) washing the zeolitic material obtained in (2) or (2a), and/or

(2c) drying the zeolitic material obtained in any of (2), (2a), or (2b).

As to the mixture prepared in (1), it is preferred that the mixture prepared in (1) comprises one or more alkali metals (AM), wherein the one or more alkali metals are preferably selected from the group consisting of Li, Na, K, Cs, and combinations of two or more thereof, more preferably from the group consisting of Li, Na, K, and combinations of two or more thereof, wherein more preferably the alkali metal is Na and/or K, and more preferably Na. Preferably, the molar ratio AM:YO₂ of the one or more alkali metals to the one or more sources for YO₂ calculated as YO₂ in the mixture prepared according to (1) ranges from 0.001 to 1.2, preferably from 0.005 to 0.9, more preferably from 0.01 to 0.6, more preferably from 0.02 to 0.4, more preferably from 0.03 to 0.2, more preferably from 0.04 to 0.15, and more preferably from 0.09 to 0.11.

While there are no specific restrictions, it is preferred that the molar ratio YO₂:X₂O₃ of the one or more sources for YO₂ calculated as YO₂ to the one or more sources for X₂O₃ calculated as X₂O₃ in the mixture prepared according to (1) ranges from 1 to 200, preferably from 5 to 150, more preferably from 10 to 100, more preferably from 15 to 70, more preferably from 20 to 50, more preferably from 25 to 45, more preferably from 30 to 40, more preferably from 32 to 38, and more preferably from 34 to 36. Preferably, the molar ratio YO₂:X₂O₃:QP in the mixture prepared according to (1) is in the range of from (5 to 200):1:(0.5 to 30), preferably from (10 to 100):1:(1 to 20), more preferably from (15 to 60):1:(3 to 15), more preferably from (20 to 40):1:(4 to 12), more preferably from (25 to 35):1:(4.5 to 9), more preferably from (27 to 33):1:(5 to 7), and more preferably from (29 to 31):1:(5.5 to 6.5).

As to step (4), it is preferred that the ion-exchange in (4) comprises one or more of: (4a) optionally exchanging one or more of the ionic non-framework elements contained in the zeolitic material obtained in (3) against H⁺ and/or NH₄⁺, preferably against H⁺; and/or

(4b) optionally calcining the zeolitic material obtained in (3) or (4a); and/or

(4c) exchanging one or more of the ionic non-framework elements contained in the zeolitic material obtained in any of (3), (4a), or (4b) against Fe²⁺ and/or Fe³⁺, preferably against Fe²⁺.

In the context of the present invention, preferably the zeolitic material having an AEI framework structure obtained in (2) is SAPO-18 and/or SSZ-39, and is preferably SSZ-39.

The present invention further relates to an iron containing zeolitic material having an AEI framework structure obtainable and/or obtained according to the process described herein above.

In the context of the present invention, the iron containing zeolitic material preferably contains non-framework phosphorous, wherein the molar ratio P:X₂O₃ of non-framework phosphorous to X₂O₃ of the zeolitic material is less than 1 and is preferably comprised in the range of from 0.0001 to 0.8, more preferably from 0.0005 to 0.7, more preferably from 0.001 to 0.6, more preferably from 0.005 to 0.5, more preferably from 0.01 to 0.4, more preferably from 0.05 to 0.3, and more preferably from 0.1 to 0.2. Preferably, the AEI framework structure of the iron containing zeolitic material does not comprise P₂O₅. The iron containing zeolitic material having an AEI framework structure is preferably SSZ-39 and/or SAPO-18, wherein more preferably the zeolitic material having an AEI framework structure is SSZ-39.

While there are no specific restrictions, it is preferred that the molar ratio Fe:YO₂ of iron to YO₂ of the iron containing zeolitic material is in the range of from 0.001 to 0.15, preferably of from 0.005 to 0.1, more preferably of from 0.01 to 0.07, more preferably of from 0.015 to 0.05, more preferably of from 0.02 to 0.045, more preferably of from 0.023 to 0.04, more preferably of from 0.025 to 0.035, more preferably of from 0.027 to 0.033, and more preferably of from 0.029 to 0.031. Preferably, the molar ratio YO₂:X₂O₃ of YO₂ to X₂O₃ of the iron containing zeolitic material is in the range of from 2 to 500, preferably of from 4 to 200, more preferably of from 8 to 100, more preferably of from 12 to 50, more preferably of from 16 to 35, more preferably of from 20 to 30, and more preferably of from 24 to 26.

In the context of the present invention Y may be any tetravalent element. Preferably, Y is selected from the group consisting of Si, Sn, Ti, Zr, Ge, and mixtures of two or more thereof, Y more preferably being Si.

In the context of the present invention X may be any trivalent element. Preferably, X is selected from the group consisting of Al, B, In, Ga, and mixtures of two or more thereof, X more preferably being Al and/or B, and more preferably being Al.

Preferably, the iron containing zeolitic material comprises Fe²⁺ and/or Fe³⁺, and more preferably Fe²⁺, wherein more preferably at least a portion of the Fe²⁺ and/or Fe³⁺, and more preferably of the Fe²⁺ is contained in the zeolitic material as ionic non-framework elements. Preferably, the iron containing zeolitic material of embodiment 39, wherein Fe²⁺ and/or Fe³⁺, preferably Fe²⁺, are contained in the zeolitic material in an amount ranging from 0.01 to 25 wt.-% based on 100 wt.-% of YO₂ comprised in the zeolitic material, preferably from 0.05 to 15.0 wt.-%, more preferably from 0.1 to 10.0 wt.-%, more preferably from 0.5 to 6.0 wt.-%, more preferably from 1.0 to 4.0 wt.-%, more preferably from 1.5 to 3.5 wt.-%, more preferably from 2.0 to 3.2 wt.-%, and more preferably from 2.2 to 3.0 wt.-%.

The iron containing zeolitic material is preferably comprised in an exhaust gas treatment system comprising an internal combustion engine and an exhaust gas conduit in fluid communication with the internal combustion engine, wherein said iron containing zeolitic material is present in the exhaust gas conduit, and wherein the internal combustion engine is preferably a lean burn gasoline engine or a diesel engine, and is more preferably a diesel engine.

The present invention further relates to an exhaust gas treatment system comprising an internal combustion engine and an exhaust gas conduit in fluid communication with the internal combustion engine, wherein an iron containing zeolitic material, preferably obtainable and/or obtained according to the process described herein above, is present in the exhaust gas conduit, and wherein the internal combustion engine is preferably a lean burn gasoline engine or a diesel engine, and is more preferably a diesel engine. Said exhaust gas treatment system preferably further comprising an oxidation catalyst, a lean NOₓ storage catalyst, and/or a catalyzed soot filter, wherein the oxidation catalyst, the lean NOₓ storage catalyst, and/or the catalyzed soot filter are preferably located upstream from the iron containing zeolitic material, and wherein the oxidation catalyst is a diesel oxidation catalyst in instances where the internal combustion engine is a diesel engine.

The present invention further relates to a method for the selective catalytic reduction of NOₓ comprising

(A) providing a gas stream comprising NOₓ;

(B) contacting the gas stream provided in (A) with an iron containing zeolitic material, preferably obtainable and/or obtained according to the process described herein above.

Preferably, the gas stream further comprises one or more reducing agents, the one or more reducing agents preferably comprising urea and/or ammonia, preferably ammonia. The gas stream preferably comprises one or more NOₓ containing waste gases, preferably one or more NOₓ containing waste gases from one or more industrial processes, wherein more preferably the NOₓ containing waste gas stream comprises one or more waste gas streams obtained in processes for producing adipic acid, nitric acid, hydroxylamine derivatives, caprolactame, glyoxal, methyl-glyoxal, glyoxylic acid or in processes for burning nitrogeneous materials, including mixtures of waste gas streams from two or more of said processes. The gas stream preferably comprises an NOₓ containing waste gas stream from an internal combustion engine, preferably from an internal combustion engine which operates under lean-burn conditions, more preferably from a lean-burn gasoline engine or from a diesel engine, and more preferably from a diesel engine.

The present invention further relates to an iron containing zeolitic material having an AEI framework structure preferably obtainable and/or obtained according to the process described herein above, for use as a catalyst and/or as a catalyst support, preferably as a catalyst for the selective catalytic reduction (SCR) of nitrogen oxides NOₓ; for the oxidation of NH₃, in particular for the oxidation of NH₃ slip in diesel systems; for the decomposition of N₂O; as an additive in fluid catalytic cracking (FCC) processes; and/or as a catalyst in organic conversion reactions, preferably in the conversion of alcohols to olefins, and more preferably as a catalyst for the selective catalytic reduction (SCR) of nitrogen oxides NOₓ in industrial or automotive exhaust gas, preferably in automotive exhaust gas.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”.
1. A process for the preparation of an iron containing zeolitic material having an AEI framework structure comprising YO₂ and X₂O₃, wherein said process comprises:
   (1) preparing a mixture comprising one or more sources for YO₂, one or more sources for X₂O₃, and one or more quaternary phosphonium (QP) cation containing compounds as structure directing agent;
   (2) heating the mixture obtained in (1) and obtaining a zeolitic material having an AEI framework structure;
   (3) calcining the zeolitic material obtained in (2) under a hydrogen gas containing atmosphere;
   (4) subjecting the zeolitic material obtained in (3) to an ion-exchange procedure with one or more Fe²⁺ and/or Fe³⁺ containing salts, preferably with one or more Fe²⁺ containing salts, for obtaining an iron containing zeolitic material having an AEI framework structure;
      wherein Y is a tetravalent element, and X is a trivalent element.
2. The process of embodiment 1, wherein the molar ratio Fe:YO₂ of iron to YO₂ of the zeolitic material obtained in (4) is in the range of from 0.001 to 0.15, preferably of from 0.005 to 0.1, more preferably of from 0.01 to 0.07, more preferably of from 0.015 to 0.05, more preferably of from 0.02 to 0.045, more preferably of from 0.023 to 0.04, more preferably of from 0.025 to 0.035, more preferably of from 0.027 to 0.033, and more preferably of from 0.029 to 0.031.
3. The process of embodiment 1 or 2, wherein in (3) the hydrogen gas containing atmosphere contains hydrogen gas in the range of from 20 to 100 vol.-%, preferably from 40 to 100 vol.-%, more preferably from 60 to 100 vol.-%, more preferably from 80 to 100 vol.-%, more preferably from 90 to 100 vol.-%, more preferably from 95 to 100 vol.-%, more preferably from 98 to 100 vol.-%, and more preferably from 99 to 100 vol.-%, wherein more preferably hydrogen gas is employed as the atmosphere for the calcining of the zeolitic material in (3).
4. The process of any of embodiments 1 to 3, wherein in (3) the hydrogen gas containing atmosphere further comprises one or more inert gases in addition to hydrogen gas, wherein preferably the hydrogen gas containing atmosphere further comprises one or more inert gases selected from the group consisting of nitrogen, helium, neon, argon, xenon, carbon monoxide, carbon dioxide, and mixtures of two or more thereof, more preferably from the group consisting of nitrogen, argon, carbon monoxide, carbon dioxide, and mixtures of two or more thereof, wherein more preferably the hydrogen gas containing atmosphere further comprises nitrogen and/or argon, and more preferably nitrogen.
5. The process of any of embodiments 1 to 4, wherein in (3) the hydrogen gas containing atmosphere contains 1 vol.-% or less of oxygen gas, preferably 0.5 vol.-% or less, more preferably 0.1 vol.-% or less, more preferably 0.05 vol.-% or less, more preferably 0.01 vol.-% or less, more preferably 0.005 vol.-% or less, more preferably 0.001 vol.-% or less, more preferably 0.0005 vol.-% or less, and more preferably 0.0001 vol.-% or less, wherein more preferably the hydrogen gas containing atmosphere does not contain oxygen gas.
6. The process of any of embodiments 1 to 5, wherein calcination in (3) is conducted at a temperature in the range of from 400 to 850° C., preferably from 450 to 700° C., more preferably from 550 to 650° C., and more preferably from 575 to 625° C.
7. The process of any of embodiments 1 to 6, wherein calcination in (3) is conducted for a duration in the range of from 2 to 48 h, preferably from 3 to 24 h, more preferably from 4 to 12 h, more preferably from 4.5 to 8 h, and more preferably from 5 to 6 h.
8. The process of any of embodiments 1 to 7, wherein in (1) the one or more quaternary phosphonium (QP) cation containing compounds comprise one or more R¹R²R³R⁴P⁺-containing compounds, wherein R¹, R², R³, and R⁴ independently from one another stand for optionally substituted and/or optionally branched (C₁-C₆)alkyl, preferably (C₁-C₅)alkyl, more preferably (C₁-C₄)alkyl, more preferably (C₂-C₃)alkyl, and more preferably for optionally substituted methyl or ethyl, wherein more preferably R¹, R², R³, and R⁴ stand for optionally substituted ethyl, preferably unsubstituted ethyl.
9. The process of any of embodiments 1 to 8, wherein in (1) the one or more quaternary phosphonium (QP) cation containing compounds are salts, preferably one or more salts selected from the group consisting of halides, preferably chloride and/or bromide, more preferably chloride, hydroxide, sulfate, nitrate, phosphate, acetate, and mixtures of two or more thereof, more preferably from the group consisting of chloride, hydroxide, sulfate, and mixtures of two or more thereof, wherein more preferably the one or more quaternary phosphonium cation containing compounds and/or the one or more quaternary ammonium cation containing compounds are hydroxides and/or chlorides, and more preferably hydroxides.
10. The process of any of embodiments 1 to 9, wherein Y is selected from the group consisting of Si, Sn, Ti, Zr, Ge, and mixtures of two or more thereof, Y preferably being Si.
11. The process of any of embodiments 1 to 10, wherein in (1) the one or more sources for YO₂ comprises one or more compounds selected from the group consisting of zeolites having a FAU framework structure, fumed silica, silica hydrosols, reactive amorphous solid silicas, silica gel, silicic acid, alkali metal silicates, sodium metasilicate hydrate, sesquisilicate, disilicate, colloidal silica, silicic acid esters, and mixtures of two or more thereof, preferably from the group consisting of zeolites having a FAU framework structure, fumed silica, sodium silicate, potassium silicate, and mixtures of two or more thereof, more preferably from the group consisting of zeolites having a FAU framework structure, fumed silica, and mixtures of two or more thereof, wherein more preferably the one or more sources for YO₂ comprises one or more zeolites having a FAU framework structure, more preferably one or more zeolites having a FAU framework structure selected from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, Na-X, US-Y, ECR-30, LZ-210, Li-LSX, SAPO-37, Na-Y, ZSM-20, ZSM-3, Zeolite X, Zeolite Y, and mixtures of two or more thereof, more preferably from the group consisting of faujasite, Na-X, US-Y, LZ-210, zeolite X, zeolite Y, and mixtures of two or more thereof, wherein more preferably the one or more sources for YO₂ comprises zeolite Y and/or US-Y, preferably zeolite Y, wherein more preferably zeolite Y and/or US-Y is employed as the source for YO₂, and more preferably zeolite Y.
12. The process of any of embodiments 1 to 11, wherein X is selected from the group consisting of Al, B, In, Ga, and mixtures of two or more thereof, X preferably being Al and/or B, and more preferably being Al.
13. The process of any of embodiments 1 to 12, wherein in (1) the one or more sources for X₂O₃ comprises one or more compounds selected from the group consisting of zeolites having a FAU framework structure, alumina, aluminates, aluminum salts, and mixtures of two or more thereof, preferably from the group consisting of zeolites having a FAU framework structure, alumina, aluminum salts, and mixtures of two or more thereof, more preferably from the group consisting of zeolites having a FAU framework structure, alumina, aluminum tri(C₁-C₅)alkoxide, AlO(OH), Al(OH)₃, aluminum halides, aluminum sulfate, aluminum phosphate, aluminum fluorosilicate, and mixtures of two or more thereof, more preferably from the group consisting of zeolites having a FAU framework structure, aluminum tri(C₂-C₄)alkoxide, AlO(OH), Al(OH)₃, aluminum chloride, aluminum sulfate, aluminum phosphate, and mixtures of two or more thereof, more preferably from the group consisting of zeolites having a FAU framework structure, aluminum tri(C₂-C₃)alkoxide, AlO(OH), Al(OH)₃, aluminum chloride, aluminum sulfate, and mixtures of two or more thereof, more preferably from the group consisting of zeolites having a FAU framework structure, Al(OH)₃, and mixtures of two or more thereof, wherein more preferably the one or more sources for X₂O₃ comprises one or more zeolites having a FAU framework structure, more preferably one or more zeolites having a FAU framework structure selected from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, Na-X, US-Y, ECR-30, LZ-210, Li-LSX, SAPO-37, Na-Y, ZSM-20, ZSM-3, Zeolite X, Zeolite Y, and mixtures of two or more thereof, more preferably from the group consisting of faujasite, Na-X, US-Y, LZ-210, zeolite X, zeolite Y, and mixtures of two or more thereof, wherein more preferably the one or more sources for YO₂ comprises zeolite Y and/or US-Y, preferably zeolite Y, wherein more preferably zeolite Y and/or US-Y is employed as the source for YO₂, and more preferably zeolite Y.
14. The process of any of embodiments 1 to 13, wherein in (1) the one or more sources for YO₂ and the one or more sources for X₂O₃ comprise one or more zeolites having a FAU framework structure, more preferably one or more zeolites having a FAU framework structure selected from the group consisting of faujasite, [Al—Ge—O]-FAU, [Al—Ge—O]-FAU, [Ga—Al—Si—O]-FAU, [Ga—Ge—O]-FAU, [Ga—Si—O]-FAU, CSZ-1, Na-X, US-Y, ECR-30, LZ-210, Li-LSX, SAPO-37, Na-Y, ZSM-20, ZSM-3, zeolite X, zeolite Y, and mixtures of two or more thereof, more preferably from the group consisting of faujasite, Na-X, US-Y, LZ-210, zeolite X, zeolite Y, and mixtures of two or more thereof, wherein more preferably the one or more sources for YO₂ and the one or more sources for X₂O₃ comprise zeolite Y and/or US-Y, preferably zeolite Y, wherein more preferably zeolite Y and/or US-Y is employed as the source for YO₂ and X₂O₃, and more preferably zeolite Y.
15. The process of any of embodiments 1 to 14, wherein the mixture prepared in (1) further comprises one or more sources for Z₂O₅, wherein Z is a pentavalent element, Z preferably being P and/or As, wherein more preferably Z is P.
16. The process of embodiment 15, wherein the one or more sources for Z₂O₅ comprises one or more phosphates and/or one or more oxides and/or one or more acids of phosphorous, preferably one or more acids of phosphorous, more preferably phosphoric acid, and wherein more preferably the source for Z₂O₅ is phosphoric acid.
17. The process of any of embodiments 1 to 16, wherein the mixture prepared according to (1) further comprises one or more solvents, wherein said one or more solvents preferably comprises water, preferably distilled water, wherein more preferably water is contained as the one or more solvents in the mixture prepared according to (1), preferably distilled water.
18. The process of embodiment 17, wherein the molar ratio H₂O:YO₂ of water to the one or more sources for YO₂ calculated as YO₂ in the mixture prepared according to (1) ranges from 1 to 80, preferably from 1.5 to 50, more preferably from 2 to 30, more preferably from 2.5 to 15, more preferably from 3 to 10, more preferably from 3.5 to 8, more preferably from 4 to 6, and more preferably from 4.5 to 5.5.
19. The process of any of embodiments 1 to 18, wherein the molar ratio QP:YO₂ of the one or more quaternary phosphonium cations to the one or more sources for YO₂ calculated as YO₂ in the mixture prepared according to (1) ranges from 0.01 to 2, preferably from 0.05 to 1.5, more preferably from 0.1 to 1, more preferably from 0.3 to 0.8, more preferably from 0.5 to 0.5, more preferably from 0.8 to 0.4, more preferably from 0.1 to 0.35, more preferably from 0.12 to 0.3, more preferably from 0.15 to 0.25, more preferably from 0.17 to 0.23, and more preferably from 0.19 to 0.21.
20. The process of any of embodiments 1 to 19, wherein in (2) the mixture is heated at a temperature ranging from 90 to 250° C., preferably from 110 to 230° C., more preferably from 130 to 210° C., more preferably from 150 to 190° C., more preferably from 160 to 180° C., and more preferably from 165 to 175° C.
21. The process of any of embodiments 1 to 20, wherein the heating in (2) is conducted under autogenous pressure, preferably under solvothermal conditions, more preferably under hydrothermal conditions.
22. The process of any of embodiments 1 to 21, wherein the in (2) the mixture is heated for a period ranging from 0.25 to 12 d, preferably from 0.5 to 9 d, more preferably from 1 to 8 d, more preferably from 2 to 7.5 d, more preferably from 3 to 7 d, more preferably from 3.5 to 6.5 d, more preferably from 4 to 6 d, and more preferably from 4.5 to 5.5 d.
23. The process of any of embodiments 1 to 22, wherein the heating in (2) involves agitating the mixture, preferably by stirring.
24. The process of any of embodiments 1 to 23, wherein after (2) and prior to (3), the process further comprises one or more of:
   (2a) isolating the zeolitic material obtained in (2), preferably by filtration, and/or
   (2b) washing the zeolitic material obtained in (2) or (2a), and/or
   (2c) drying the zeolitic material obtained in any of (2), (2a), or (2b).
25. The process of any of embodiments 1 to 24, wherein mixture prepared in (1) comprises one or more alkali metals (AM), wherein the one or more alkali metals are preferably selected from the group consisting of Li, Na, K, Cs, and combinations of two or more thereof, more preferably from the group consisting of Li, Na, K, and combinations of two or more thereof, wherein more preferably the alkali metal is Na and/or K, and more preferably Na.
26. The process of embodiment 25, wherein the molar ratio AM:YO₂ of the one or more alkali metals to the one or more sources for YO₂ calculated as YO₂ in the mixture prepared according to (1) ranges from 0.001 to 1.2, preferably from 0.005 to 0.9, more preferably from 0.01 to 0.6, more preferably from 0.02 to 0.4, more preferably from 0.03 to 0.2, more preferably from 0.04 to 0.15, and more preferably from 0.09 to 0.11.
27. The process of any of embodiments 1 to 26, wherein the molar ratio YO₂: X₂O₃ of the one or more sources for YO₂ calculated as YO₂ to the one or more sources for X₂O₃ calculated as X₂O₃ in the mixture prepared according to (1) ranges from 1 to 200, preferably from 5 to 150, more preferably from 10 to 100, more preferably from 15 to 70, more preferably from 20 to 50, more preferably from 25 to 45, more preferably from 30 to 40, more preferably from 32 to 38, and more preferably from 34 to 36.
28. The process of any of embodiments 1 to 27, wherein the molar ratio YO₂: X₂O₃:QP in the mixture prepared according to (1) is in the range of from (5 to 200) : 1:(0.5 to 30), preferably from (10 to 100):1:(1 to 20), more preferably from (15 to 60):1:(3 to 15), more preferably from (20 to 40):1:(4 to 12), more preferably from (25 to 35):1:(4.5 to 9), more preferably from (27 to 33):1:(5 to 7), and more preferably from (29 to 31):1:(5.5 to 6.5).
29. The process of any of embodiments 1 to 28, wherein the ion-exchange in (4) comprises one or more of:
   (4a) optionally exchanging one or more of the ionic non-framework elements contained in the zeolitic material obtained in (3) against H⁺ and/or NH₄⁺, preferably against H⁺;
   and/or
   (4b) optionally calcining the zeolitic material obtained in (3) or (4a);
   and/or
   (4c) exchanging one or more of the ionic non-framework elements contained in the zeolitic material obtained in any of (3), (4a), or (4b) against Fe²⁺ and/or Fe³⁺, preferably against Fe²⁺.
30. The process of any of embodiments 1 to 29, wherein the zeolitic material having an AEI framework structure obtained in (2) is SAPO-18 and/or SSZ-39, and is preferably SSZ-39.
31. An iron containing zeolitic material having an AEI framework structure obtainable and/or obtained according to the process of any of embodiments 1 to 30.
32. The iron containing zeolitic material of embodiment 31, wherein the zeolitic material contains non-framework phosphorous, wherein the molar ratio P:X₂O₃ of non-framework phosphorous to X₂O₃ of the zeolitic material is less than 1 and is preferably comprised in the range of from 0.0001 to 0.8 , more preferably from 0.0005 to 0.7, more preferably from 0.001 to 0.6, more preferably from 0.005 to 0.5, more preferably from 0.01 to 0.4, more preferably from 0.05 to 0.3, and more preferably from 0.1 to 0.2.
33. The iron containing zeolitic material of embodiment 32, wherein the AEI framework structure of the zeolitic material does not comprise P₂O₅.
34. The iron containing zeolitic material of any of embodiments 31 to 33, wherein the zeolitic material having an AEI framework structure is SSZ-39 and/or SAPO-18, wherein preferably the zeolitic material having an AEI framework structure is SSZ-39.
35. The iron containing zeolitic material of any of embodiments 31 to 34, wherein the molar ratio Fe:YO₂ of iron to YO₂ of the zeolitic material is in the range of from 0.001 to 0.15, preferably of from 0.005 to 0.1, more preferably of from 0.01 to 0.07, more preferably of from 0.015 to 0.05, more preferably of from 0.02 to 0.045, more preferably of from 0.023 to 0.04, more preferably of from 0.025 to 0.035, more preferably of from 0.027 to 0.033, and more preferably of from 0.029 to 0.031.
36. The iron containing zeolitic material of any of embodiments 31 to 35, wherein the molar ratio YO₂:X₂O₃ of YO₂ to X₂O₃ of the zeolitic material is in the range of from 2 to 500, preferably of from 4 to 200, more preferably of from 8 to 100, more preferably of from 12 to 50, more preferably of from 16 to 35, more preferably of from 20 to 30, and more preferably of from 24 to 26.
37. The iron containing zeolitic material of any of embodiments 31 to 36, wherein Y is selected from the group consisting of Si, Sn, Ti, Zr, Ge, and mixtures of two or more thereof, Y preferably being Si.
38. The iron containing zeolitic material of any of embodiments 31 to 37, wherein X is selected from the group consisting of Al, B, In, Ga, and mixtures of two or more thereof, X preferably being Al and/or B, and more preferably being Al.
39. The iron containing zeolitic material of any of embodiments 31 to 38, wherein the zeolitic material comprises Fe²⁺ and/or Fe³⁺, and preferably Fe²⁺, wherein more preferably at least a portion of the Fe²⁺ and/or Fe³+, and more preferably of the Fe²⁺ is contained in the zeolitic material as ionic non-framework elements.
40. The iron containing zeolitic material of embodiment 39, wherein Fe²⁺ and/or Fe³⁺, preferably Fe²⁺, are contained in the zeolitic material in an amount ranging from 0.01 to 25 wt.-% based on 100 wt.-% of YO₂ comprised in the zeolitic material, preferably from 0.05 to 15.0 wt.-%, more preferably from 0.1 to 10.0 wt.-%, more preferably from 0.5 to 6.0 wt.-%, more preferably from 1.0 to 4.0 wt.-%, more preferably from 1.5 to 3.5 wt.-%, more preferably from 2.0 to 3.2 wt.-%, and more preferably from 2.2 to 3.0 wt.-%.

41. The iron containing zeolitic material according to any of embodiments 31 to 40, wherein the iron containing zeolitic material is comprised in an exhaust gas treatment system comprising an internal combustion engine and an exhaust gas conduit in fluid communication with the internal combustion engine, wherein said iron containing zeolitic material 1 is present in the exhaust gas conduit, and wherein the internal combustion engine is preferably a lean burn gasoline engine or a diesel engine, and is more preferably a diesel engine.
42. An exhaust gas treatment system comprising an internal combustion engine and an exhaust gas conduit in fluid communication with the internal combustion engine, wherein an iron containing zeolitic material according to any of embodiments 31 to 40 is present in the exhaust gas conduit, and wherein the internal combustion engine is preferably a lean burn gasoline engine or a diesel engine, and is more preferably a diesel engine.
43. The exhaust gas treatment system of embodiment 42, said exhaust gas treatment system further comprising an oxidation catalyst, a lean NOₓ storage catalyst, and/or a catalyzed soot filter, wherein the oxidation catalyst, the lean NOₓ storage catalyst, and/or the catalyzed soot filter are preferably located upstream from the iron containing zeolitic material, and wherein the oxidation catalyst is a diesel oxidation catalyst in instances where the internal combustion engine is a diesel engine.
44. A method for the selective catalytic reduction of NOₓ comprising
   (A) providing a gas stream comprising NOₓ;
   (B) contacting the gas stream provided in (A) with an iron containing zeolitic material according to any of embodiments 31 to 40.
45. The method of embodiment 44, wherein the gas stream further comprises one or more reducing agents, the one or more reducing agents preferably comprising urea and/or ammonia, preferably ammonia.
46. The method of embodiments 44 or 45, wherein the gas stream comprises one or more NOₓ containing waste gases, preferably one or more NOₓ containing waste gases from one or more industrial processes, wherein more preferably the NOₓ containing waste gas stream comprises one or more waste gas streams obtained in processes for producing adipic acid, nitric acid, hydroxylamine derivatives, caprolactame, glyoxal, methyl-glyoxal, glyoxylic acid or in processes for burning nitrogeneous materials, including mixtures of waste gas streams from two or more of said processes.
47. The method of any of embodiments 44 to 46, wherein the gas stream comprises an NOₓ containing waste gas stream from an internal combustion engine, preferably from an internal combustion engine which operates under lean-burn conditions, more preferably from a lean-burn gasoline engine or from a diesel engine, and more preferably from a diesel engine.
48. Use of an iron containing zeolitic material having an AEI framework structure according to any of embodiments 31 to 40 as a catalyst and/or as a catalyst support, preferably as a catalyst for the selective catalytic reduction (SCR) of nitrogen oxides NOₓ; for the oxidation of NH₃, in particular for the oxidation of NH₃ slip in diesel systems; for the decomposition of N₂O; as an additive in fluid catalytic cracking (FCC) processes; and/or as a catalyst in organic conversion reactions, preferably in the conversion of alcohols to olefins, and more preferably as a catalyst for the selective catalytic reduction (SCR) of nitrogen oxides NOₓ in industrial or automotive exhaust gas, preferably in automotive exhaust gas.

### DESCRIPTION OF THE FIGURES

FIG. 1: shows a comparison of the XRD patterns of the H-SSZ-39(N), H-SSZ-39(P)-A and H-SSZ-39(P)-H as prepared in the examples. The X-ray diffraction pattern shown in the figure was measured using Cu K alpha-1 radiation. In the respective diffractogram, the diffraction angle 2 theta in ° is shown along the abscissa and the intensities are plotted along the ordinate.

### EXAMPLES

### Comparative Example 1: Synthesis of SSZ-39(N) Using Quaternary Ammonium Containing Structure Directing Agent

The following synthesis of SSZ-39(N) is based on the synthetic methodologies described in U.S. Pat. No. 5,958,370 and M. Moliner et al. in Chem. Commun. 2012, 48, pages 8264-8266.

### Synthesis of N,N-dimethyl-3,5-dimethylpiperidinium Hydroxide (Nitrogen Containing Compound Structure Directing Agent)

N,N-dimethyl-3,5-dimethylpiperidinium hydroxide was prepared as described in M. Molner et al., Chem. Comm., 2012, 48, 8264-6266 as detailed in the Electronic Supplementary Information (ESI) thereof, under heading 1.1.2.1—SSZ-39-OSDA Synthesis.

### Synthesis of SSZ-39(N)

4 g of a solution of the above obtained N,N-dimethyl-3,5-dimethylpiperidinium hydroxide (0.56 mmol OH⁻/g) is mixed with 6.1 g of water and 0.20 g of aqeuous 1.0 M NaOH solution. 0.25 g of Ammonium exchanged Y zeolite (JRC-HY-5.3; Si/Al₂O₃=5.3; JGC Catalysts and Chemicals Ltd.) is added to this solution and, finally, 2.5 g of Fumed Silica (Cab-O-Sil M5D) is added. The thus obtained mixture has the molar composition: 1 Si:0.05 Al:0.15 OSDA:0.45 Na:30 H₂O.

The resulting mixture is then sealed in an autoclave and heated at 150° C. and stirred at 30 rpm for 3 days. After pressure release and cooling to room temperature the SSZ-39(N) product was obtained having a SiO₂ /Al₂O₃ mole ratio of 40.

The thus obtained SSZ-39(N) product was then calcined in air in a muffle furnace at 600° C. for 6 hours which provided the Na-SSZ-39(N).

Subsequently, the Na-SSZ-39(N) was then NH₄⁺ ion exchanged using NH₄NO₃ by treating a 1:1 mixture of the Na-SSZ-39(N):NH₄NO₃ by slurrying in water in a weight ratio of water: Na-SSZ-39 of 25-50:1 at 95° C. for 2 hours, followed by filtration to provide NH₄⁺ SSZ-39(N).

The thus obtained NH₄⁺ SSZ-39(N) was then calcined in air in a muffle furnace at 600° C. for 3 hours which provided the H-form, H-SSZ-39(N).

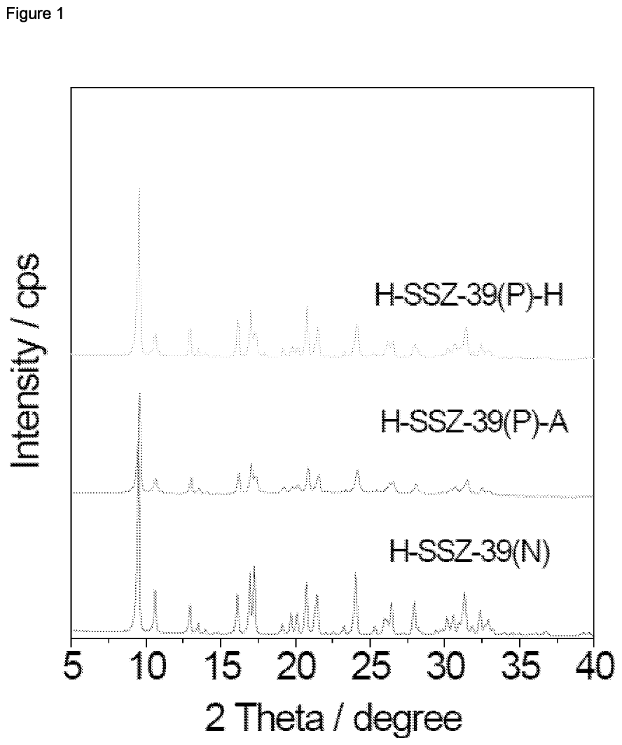

The XRD for the H-SSZ-39(N) is provided in FIG. 1.

### Comparative Example 2: Synthesis of SSZ-39(P)-A Using Quaternary Phosphonium Containing Structure Directing Agent (Calcination in Air)

The following synthesis of SSZ-39(N) is based on the synthetic methodology described in T. Sano et al., Chem. Lett. 2014, 43, page 302.

### Synthesis of SSZ-39(P)

A solution of tetraethylphosphonium hydroxide is mixed with an aqueous NaOH solution and Zeolite Y (CBV-720, Zeolite, Si/Al₂O₃=30) for obtaining a mixture having the molar composition: 1 Si:0.067 Al:0.2 OSDA:0.1 Na: 5 H₂O

The resulting mixture is then sealed in an autoclave and heated at 170° C. and stirred at 40 rpm for 5 days. After pressure release and cooling to room temperature SSZ-39(P) was obtained.

### SSZ-39(P)-A

The thus obtained SSZ-39(P) product was then calcined in air in a muffle furnace at 600° C. for 6 hours which provided the sodium form, Na-SSZ-39(P)-A.

Subsequently, the Na-SSZ-39(P)-A was then NH₄⁺ ion exchanged using NH₄NO₃ in accordance with the treatment described in Comparative Example 1.

The thus obtained NH₄⁺SSZ-39(P)-A was then calcined in air in a muffle furnace at 600° C. for 3 hours which provided the H-form, H-SSZ-39(P)-A.

The XRD for H-SSZ-39(P)-A is provided in FIG. 1.

Reference Example 1: Synthesis of SSZ-39(P)-H using quaternary phosphonium containing structure directing agent (calcination under hydrogen atmosphere)

The Protocol for the synthesis of SSZ-39(P) as detailed in Comparative Example 2 herein above was repeated, except that the intermediate SSZ-39(P) was calcined in a hydrogen atmosphere for providing the sodium form, Na-SSZ-39(P)-H.

Subsequently, the Na-SSZ-39(P)-H was then NH₄⁺ ion exchanged and calcined as described in Comparative Example 2 for obtaining the H-form, H-SSZ-39(P)-H.

The XRD for H-SSZ-39(P)-H is provided in FIG. 1.

### Example 1: Iron Ion Exchange

Comparative Example 1 (H-SSZ-39(N)), Comparative Example 2 (H-SSZ-39(P)-A) and Reference Example 1 (H-SSZ-39(P)-H) samples were respectively treated with an aqueous 0.2 M iron (II) nitrate solution at room temperature for 24 hours. Subsequently, each of the samples were then heated at 500° C. for 5 hours under air, which provided Fe-SSZ-39(N), Fe-SSZ-39(P)-A and Fe-SSZ-39(P)-H samples, respectively.

It has surprisingly been found that the use of a quaternary phosphonium cation containing compound and its removal via calcination in a hydrogen atmosphere leads to an AEI type framework structure with different properties compared to the corresponding zeolitic material obtained using quaternary ammonium containing compounds as structure directing agents, in particular when subsequently subject to identical procedures for ion exchange with iron. In particular, it has unexpectedly been found that upon comparison of the zeolitic materials as obtained from Comparative Example 1 (H-SSZ-39(N)) and Reference Example 1 (H-SSZ-39(P)-H) which were subject to the same ion exchange procedure with iron, the zeolitic material obtained according to Reference Example 1 displayed a higher tendency to Fe ion cluster formation than the zeolitic material obtained according to Comparative Example 1. Furthermore, under identical conditions of ion exchange using a solution with the same iron concentration, the zeolitic material obtained according to Reference Example 1 displayed higher loadings of iron compared to the zeolitic material obtained according to both Comparative Example 1 and Reference Example 2 (H-SSZ-39(P)-A).

### LIST OF THE CITED PRIOR ART REFERENCES

U.S. Pat. No. 5,958,370
Moliner, M. et al. in Chem. Commun. 2012, 48, pages 8264-8266
Maruo, T. et al. in Chem. Lett. 2014, 43, page 302-304
Martin, N. et al. in Chem. Commun. 2015, 51, 11030-11033
US 2011/0250127 A1
Martin, N. et al. in Chem Cat Chem 2017, 9, pages 1754-1757.

1. A process for the preparation of an iron-containing zeolitic material having an AEI framework structure comprising YO₂ and X₂O₃, the process comprising:
(1) preparing a mixture comprising one or more sources for YO₂, one or more sources for X₂O₃, and one or more quaternary phosphonium (QP) cation-containing compounds as structure directing agent;
(2) heating the mixture obtained in (1) and obtaining a zeolitic material having an AEI framework structure;
(3) calcining the zeolitic material obtained in (2) under a hydrogen gas containing gas-containing atmosphere; and
(4) subjecting the zeolitic material obtained in (3) to an ion-exchange procedure with one or more Fe²⁺ and/or Fe³⁺ containing salts, for obtaining an iron-containing zeolitic material having an AEI framework structure,
wherein Y is a tetravalent element, and X is a trivalent element.

2. The process of claim 1, wherein in (3) the hydrogen gas-containing atmosphere contains comprises hydrogen gas in the range of from 20 to 100 vol.-%.

3. The process of claim 1, wherein in (3) the hydrogen gas-containing atmosphere contains comprises 1 vol-% or less of oxygen gas.

4. The process of claim 1, wherein calcination in (3) is conducted at a temperature in the range of from 400 to 850° C.

5. The process of claim 1, wherein calcination in (3) is conducted for a duration in the range of from 2 to 48 h.

6. The process of claim 1, wherein in (1) the one or more quaternary phosphonium cation-containing compounds comprise one or more R¹R²R³R⁴⁺-containing compounds, wherein R¹, R², R³, and R⁴ independently from one another stand for optionally substituted and/or optionally branched (C₁-C₆)alkyl.

7. The process of claim 1, wherein Y is at least one selected from the group consisting of Si, Sn, Ti, Zr, Ge, and mixtures thereof.

8. The process of claim 1, wherein X is at least one selected from the group consisting of Al, B, In, Ga, and mixtures thereof.

9. The process of claim 1, wherein the heating in (2) is conducted under autogenous pressure.

10. An iron-containing zeolitic material having an AEI framework structure obtainable and/or obtained according to the process of claim 1.

11. The iron-containing zeolitic material of claim 10, wherein the zeolitic material comprises non-framework phosphorous, wherein the molar ratio P:X₂O₃ of non-framework phosphorous to X₂O₃ of the zeolitic material is less than 1.

12. The iron-containing zeolitic material of claim 10, wherein Y is at least one selected from the group consisting of Si, Sn, Ti, Zr, Ge, and mixtures thereof

13. The iron-containing zeolitic material of claim 10, wherein X is at least one selected from the group consisting of Al, B, In, Ga, and mixtures thereof.

14. A method for the selective catalytic reduction of NOₓ, the method comprising:
(A) providing a gas stream comprising NOₓ; and
(B) contacting the gas stream provided in (A) with an iron-containing zeolitic material according to claim 10.

15. A process, comprising employing iron-containing zeolitic material having an AEI framework structure according to claim 10 as a catalyst and/or as a catalyst support.
